(19) United States
(12) Patent Application Publication
(10) Pub. No.: US 2026/0361179 A1
(43) Pub. Date: Nov. 12, 2026

(54) RETROFITTABLE ELECTRIC MOTOR ASSEMBLY AND ELECTRIC DRAWWORKS SYSTEM COMPRISING SAME

(71) Applicant: Sparta Engineering Inc., Calgary (CA)

(72) Inventor: Matthew Justin FOX, Foam Lake (CA)

(73) Assignee: Sparta Engineering Inc., Calgary, AB (CA)

(21) Appl. No.: 19/116,745

(22) PCT Filed: Sep. 28, 2023
(86) PCT No.: PCT/CA2023/051291

§ 371 Date: Mar. 28, 2025

Related U.S. Application Data
(60) Provisional application No. 63/410,859, filed on Sep. 28, 2022.

(51) Int. Cl. H02K 7/14; B66D 3/20; H02K 7/102; H02K 7/18

(52) U.S. Cl. CPC H02K 7/14; B66D 3/20; H02K 7/102; H02K 7/1807; H02K 2213/12

(57) ABSTRACT

A method and apparatus for a retrofittably attachable electric motor assembly configured for use in controlling a drawworks of a mobile service rig. This electric motor assembly includes an electric motor configured for direct attachment to an auxiliary driveshaft of the drawworks and a disc brake configured to hold the motor in a stationary position when the drawworks is stopped.

### FIELD OF THE INVENTION

The present invention pertains to the field of oilfield exploration, and in particular to the control of drawworks of a mobile service rig.

### BACKGROUND

Oil field mobile service rigs, also commonly referred to as mobile service rigs, are driven from oil field site to oil field site and are used when turning exploratory oil wells into producing oil wells, shutting oil wells in, repairing oil wells and abandoning oil wells. These rigs include a movable mast, cab, drawworks and diesel motor. This diesel motor has dual use. It is used to propel the mobile service rig as it is driven from oil field site to oil field site and is also used to control the drawworks of the mobile service rig.

The diesel motor of mobile service rigs is inefficient when used to control the drawworks. Accordingly, there is a need for an apparatus and method that at least partially addresses one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide a retrofittable electric motor assembly and methods to control the drawworks of a mobile service rig. This method and apparatus can efficiently control the drawworks through the use of a retrofittable motor attached to the auxiliary shaft of the drawworks.

An aspect of the disclosure provides an electric motor assembly configured for use in controlling a drawworks assembly of a mobile service rig. This electric motor assembly includes an electric motor configured for attachment to an auxiliary driveshaft of the drawworks and a disc brake configured to hold the motor in a stationary position when the drawworks is stopped.

An aspect of the disclosure provides an electric drawworks system adapted to move equipment in and out of oil wells, the system comprising: an electric motor assembly in accordance with the present invention; and a drawworks.

An aspect of the disclosure provides a method for retrofitting an electric motor assembly to an auxiliary driveshaft of a drawworks including the removal the auxiliary brake system from the auxiliary driveshaft and attaching the double air gap electric motor to the auxiliary driveshaft.

Embodiments have been described above in conjunction with aspects of the present disclosure upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 illustrates the mobile service rig with an electric drawworks system according to an embodiment of the present disclosure;

FIG. 2a is a perspective view of a prior art drawworks system showing the components of a prior art auxiliary brake system prior to its removal;

FIG. 2b is an exploded perspective view showing components of the prior art auxiliary brake system of FIG. 2a;

FIG. 3a is a perspective view of an electric drawworks system with a retrofittable motor assembly according to an embodiment of the present disclosure, prior to installation;

FIG. 3b is a perspective view showing the components of the retrofittable motor assembly of FIG. 3a according to an embodiment of the present disclosure, prior to installation;

FIG. 4a illustrates a cross-sectional view of a retrofittable motor assembly according to an embodiment of the present disclosure;

FIG. 4b illustrates an exploded side view of a retrofittable motor assembly according to an embodiment of the present disclosure;

FIG. 5 illustrates a partial cross-sectional view of a retrofittable motor assembly according to an embodiment of the present disclosure;

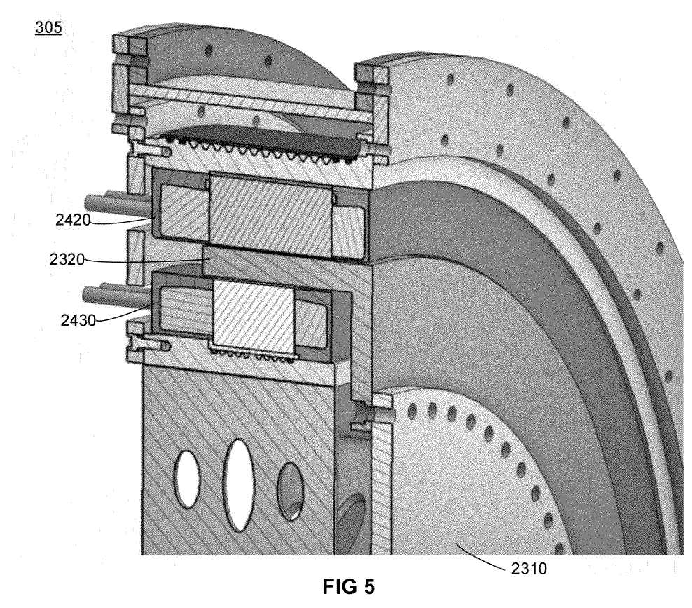

FIG. 6 is a top view of a portable auxiliary system according to an embodiment of the present disclosure;

FIG. 7 is a top view of a mobile service rig with an electric drawworks system comprising a retrofittable motor assembly connected to a portable auxiliary system according to an embodiment of the present disclosure;

FIG. 8 is a perspective view of the mobile service rig of FIG. 7 according to an embodiment of the present disclosure;

FIG. 9 illustrates torque and power curves as a function of speed of a retrofittable motor assembly according to an embodiment of the present disclosure;

It will be noted that throughout the appended drawings, like features are identified by like reference numerals.

### DETAILED DESCRIPTION

Mobile service rigs are driven from oil field site to oil field site and are used for servicing one or more oil wells at these sites. These rigs include a movable mast and drawworks used to move equipment in and out of oil wells. In addition, the mobile service rig includes a diesel motor that is used to propel the mobile service rig and to indirectly control the drawworks. However, the efficiency of this diesel motor when it controls the drawworks is typically low.

An embodiment of this disclosure includes a motor assembly that can be retrofittably attached to the auxiliary shaft of the drawworks such that this motor assembly can control the drawworks while still allowing the diesel motor to provide propulsion to the mobile service rig. Retrofittable attachment of the motor assembly allows attachment of the assembly without disconnecting the existing diesel motor of the mobile service rig. This motor assembly can be retrofittably attached without modifying the existing drive train of the mobile service rig and without modifying the primary brake system of the drawworks.

An embodiment of this disclosure includes an electric drawworks system comprising a motor assembly and drawworks.

In some embodiments, the motor assembly can be retrofittably attached to the drawworks and connected to the main line drum without an impact on the sand line of the mobile service rig.

In an embodiment, despite the motor being retrofittably attached, the diesel motor does not affect either the drawworks or the motor assembly. In one embodiment, this can be achieved by including a freewheel (also known in the art as a clutch) so that the diesel motor does not act as a brake and does not impede operation of the motor or drawworks.

This retrofittable motor assembly can be used to control the drawworks unobtrusively. Unobtrusive control can mean that the retrofittable motor assembly can control the drawworks without disconnecting the diesel motor. As a result, the drawworks can be driven by the electric motor or the diesel motor. As a non-limiting example, an operator can turn on a console when the operator wants to control the drawworks using the electric motor. On the other hand, if the operator wants the drawworks to be controlled by the diesel motor and not the electric motor, the operator can turn the console off.

In some embodiments of this disclosure, this retrofittable motor assembly comprises a synchronous, brushless dual air gap permanent magnet motor and can include a plurality of permanent magnets.

A person skilled in the art will understand that the width of an electric motor can be related to the power a motor can produce for a given diameter, or envelope, of the motor. Additionally, a person skilled in the art will understand that a motor's power can be increased by increasing the widths of one or both of the stator and rotor of a motor while keeping the diameter of the motor constant.

In some embodiments, as a non-limiting example, the electric motor for oil wells in western Canada, California, New Mexico, and North Dakota can be a 400-horsepower motor. Since the maximum amount of power produced by an electric motor can be related to the width of the electric motor, this 400-horsepower motor can by 8 inches wide.

The motor assembly can be retrofittably attached in part because it has been designed so that it can be directly attached to the drawworks without extending beyond the side of the mobile service rig, In another embodiment, a non-limiting example is an electric motor for oil wells in Texas can be a 600-horsepower motor. Again, since the power produced by an electric motor can be related to the width of the electric motor, this 600-horsepower can be 12 inches wide.

In some embodiments, the average power requirements of the retrofittable electric motor assembly driving the drawworks would be considered by a person skilled in the art to be relatively low when compared to the maximum power required. This relatively low average power contrasts with the power of prior art motors driving the drawworks. In the prior art, motors driving drawworks were required to produce a large amount of power to compensate for the power lost through the transmission of the mobile service rig.

In some embodiments, as the equipment is lowered into an oil well throughout the day, the electric motor can generate energy stored in a battery. This stored energy can reduce the amount of energy drawn from a power grid or a power generator and as a result, this ability to charge the battery when lowering equipment is an advantage of the present system.

In some embodiments, a method can be used to control the motor, so its torque does not damage the mobile service rig or injure its operator when the motor begins to rotate from a stopped position. This technique can also analyze the power supply to ensure the power supply is provided with the necessary power from any combination of the power grid or generator. This technique can also ensure that the power supply can sink the power generated by the motor as equipment is lowered into an oil well.

In some embodiments, supercapacitors can be employed to increase the motor speed so equipment can be raised quickly enough.

A person skilled in the art will also understand that another way to increase the power of a motor can be through the addition of a second rotor. As a result, this retrofittable motor assembly can include a rotor positioned between a first stator and a second stator such that the two stators work together to produce a high-power density relative to the size of the motor without requiring one or more other gearboxes or power transmission devices. A person skilled in the art will also understand the high-power density of a motor can refer to the relative ratio of maximum power potential to the physical volume of the motor. This high-power density can result in high power, which can be desirable when controlling the drawworks while at the same time allowing the motor to have compact dimensions and maintain a small footprint. High power can be desirable when controlling the drawworks as it is used to lower equipment into an oil well or raise equipment from an oil well. The compact dimensions of the motor assembly are particularly advantageous for allowing a retrofitted mobile service rig to be driven down a highway.

This motor can also be designed to exhibit near full torque when stopped. A person skilled in the art will understand that torque and power are directly proportional. As a result, since a person skilled in the art will understand that more power is required when equipment is accelerated from a standstill as it is raised or lowered, a motor that exhibits full torque when accelerating equipment from a standstill can be beneficial.

In some embodiments, the double air gap motor can act as a motor, transmission and brake.

In some embodiments the double air gap motor is a low speed, high torque motor.

In some embodiments, equipment can be lowered into an oil well using the retrofitted drawworks without causing the motor to rotate and lower the equipment. Lowering equipment in this way can be achieved through gravity and using the torque characteristics of the motor due to the motor acting like a brake to control the descent of the equipment. Additionally, in one embodiment, using gravity and the torque characteristics results in the motor operating as a generator to charge a battery.

In some embodiments, an additional disk brake is included in the motor to hold equipment when the motor is stopped. This disk brake or the existing band brake, or a combination thereof, can be used to hold equipment when the motor is stopped to reduce the electrical energy required by the motor.

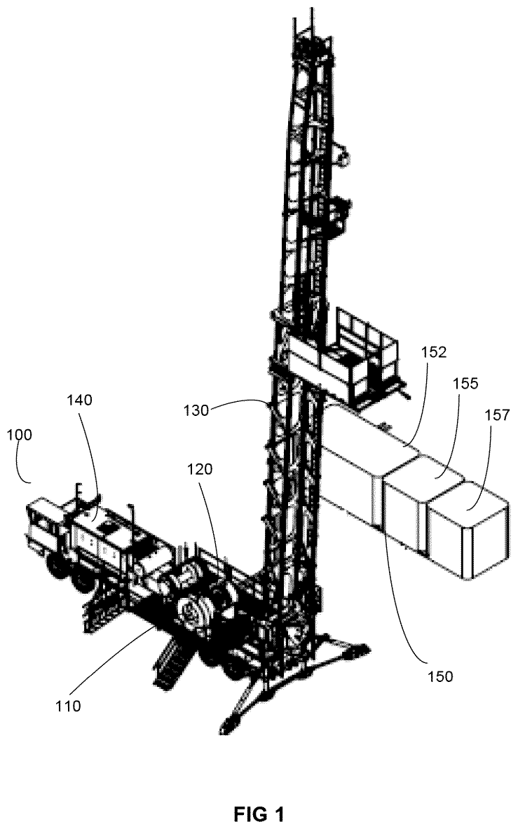

FIG. 1 illustrates the mobile service rig 100 with movable mast 130. FIG. 1 also illustrates motor assembly 110 of embodiments of this disclosure that has been retrofittably attached to the auxiliary shaft of drawworks 120 such that the motor of motor assembly 110 can control drawworks 120.

In some embodiments, auxiliary system 150 for use with motor assembly 110 can include battery pack 152. Battery pack 152 can be charged using any combination of supercapacitor, connection to the electrical power grid, one or more solar panels, one or more wind turbines, and/or genset. Auxiliary system 150 can also include a generator 155 and controls 157.

In some embodiments, the battery pack 152 that can be used to power the electric motor of motor assembly 110 can be optimized by operating the electric motor at optimal speed and torque. These speeds and torques can be calculated within the first moments when equipment is raised. These speeds and torques can be used to create an energy plan that can be used to size the battery pack 152.

In some embodiments, battery pack 152 can supply between 800V to 840V.

In some embodiments, battery pack 152 can use a heat sink to reduce the size of a battery pack 152 while maintaining power density and battery longevity. This battery pack 152 can also offer large storage capacity as well as respond to instantaneous changes in current consumption/supply.

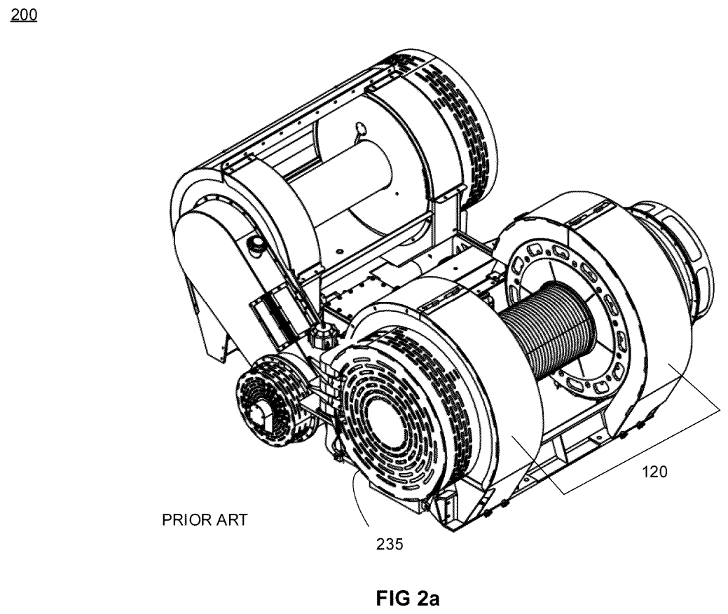

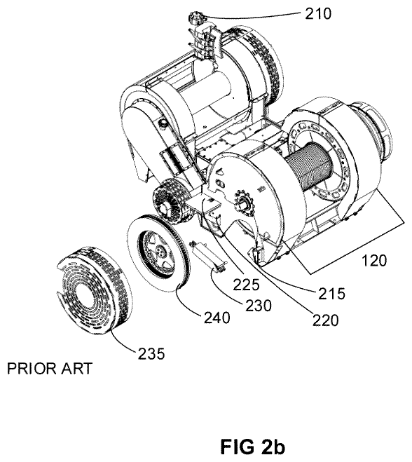

FIG. 2a illustrates a prior art system 200 with shroud 235 of the auxiliary brake system and drawworks 120. The auxiliary brake system (and shroud 235) will be replaced with retrofit motor assembly 110 as described herein.

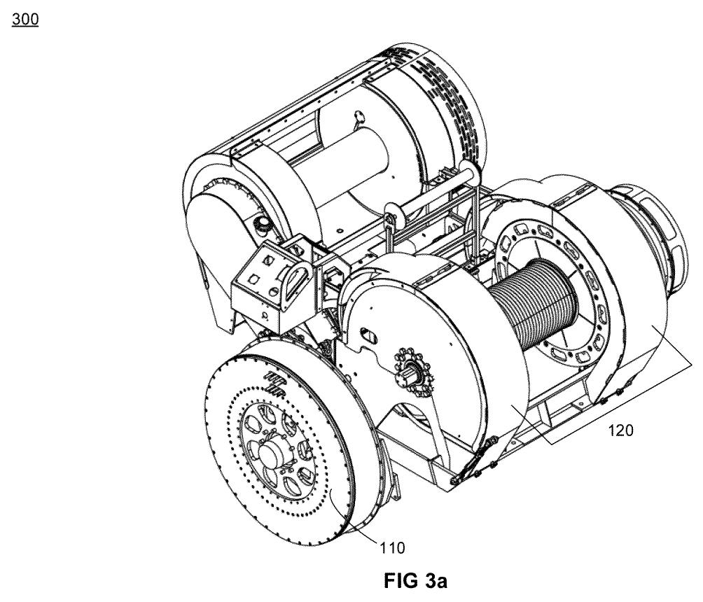

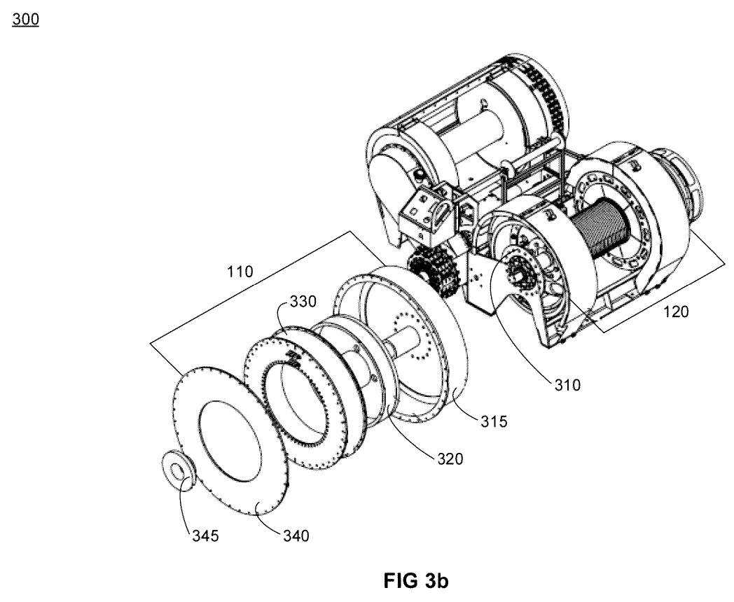

FIG. 3a illustrates an embodiment of an electric drawworks system 300 comprising motor assembly 110 and drawworks 120 with retrofit motor assembly 110 and drawworks 120. Retrofit motor assembly 110 is mounted on drawworks 120 to control drawworks 120 as described herein.

FIG. 2b and FIG. 3b illustrate the steps required to retrofit motor assembly 110 of embodiments of this disclosure to the drawworks 120 of a mobile service rig 100 to provide the electric drawworks system. The first step when retrofitting motor assembly 110 of the embodiments of this disclosure is illustrated by FIG. 2b which illustrates removal of the auxiliary brake system from the drawworks 120. The auxiliary brake system can be removed by removing e-brake mounts 215, 220, and 225 from the frame of drawworks 120. Also, the crown saver cylinder 230, shroud 235, disc brake 240 and brake caliper 210 are to be removed.

The subsequent steps when retrofitting motor assembly 110 of this disclosure is illustrated by FIG. 3b which illustrates the components of the electric motor assembly to be installed. The installation begins with the addition of bolting flange mount 310 to the existing drawworks 120 frame. Next, motor bell housing 315 is bolted to flange mount 310, and motor rotor 320, motor twin stator assembly 330, motor mounting ring 340 and then brake rotor 345 are all installed so that motor 110 and drawworks 120 are coupled and vibrate at the same frequency. This vibration at the same frequency can reduce metal fatigue and as a result, increase the operational life of motor 110. An additional advantage of vibrating at the same frequency is improved motor 110 performance.

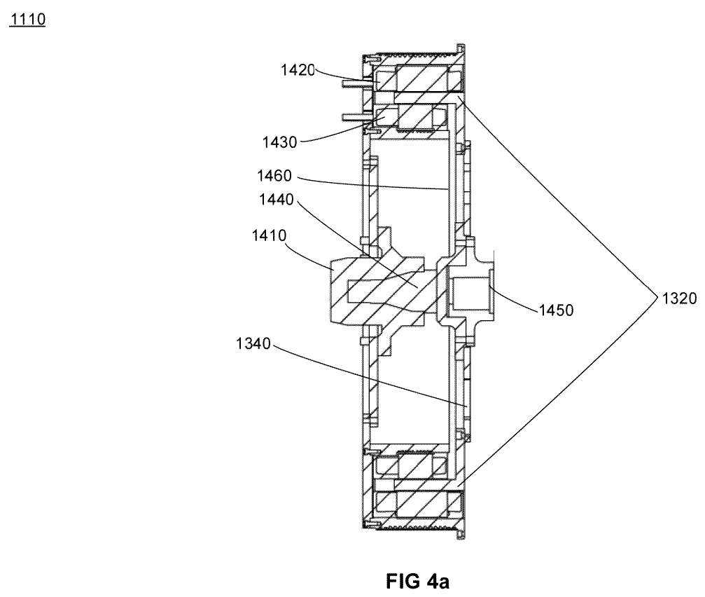

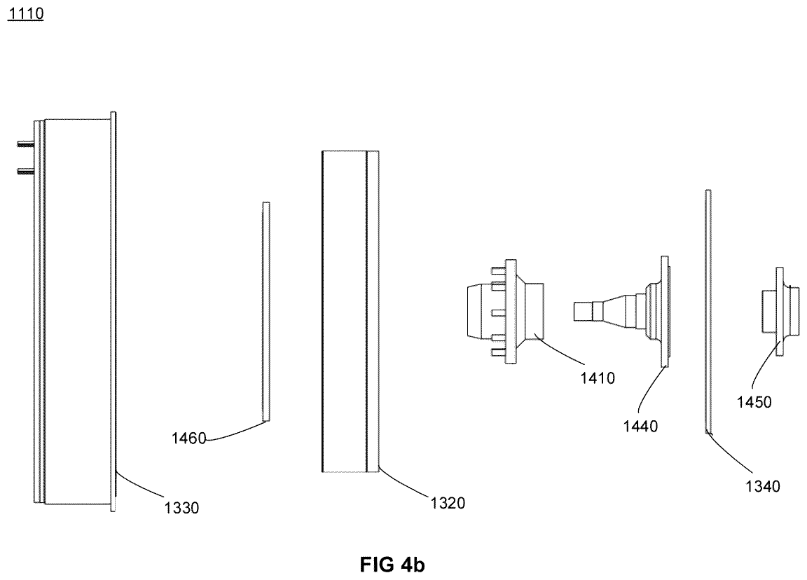

FIG. 4a illustrates a cross-sectional view of a retrofit motor assembly 1110. Retrofit motor assembly 1110 is comprised of motor rotor 1320, motor ring 1340, hub 1410, first stator 1420, second stator 1430, spindle 1440, shaft adaptor 1450 and stator mounting ring 1460.

FIG. 4b illustrates an exploded view of a retrofit motor assembly 1110. Retrofit motor assembly 1110 is comprised of motor rotor 1320, motor twin stator assembly 1330, motor ring 1340, hub 1410, spindle 1440, shaft adaptor 1450 and stator mounting ring 1460.

FIG. 54 illustrates a partial cross-sectional view of a double air gap motor 305 of embodiment of this disclosure. This motor includes a rotor 2320 placed between a first stator 2420 and also a second stator 2430. This arrangement of a rotor 2320 placed between stator 2420 and stator 2430 can result in the power generated by two electric motors within the same package. The advantage of these two motors in one is an increased power density while keeping the volume, and therefore physical size, of the motor the same.

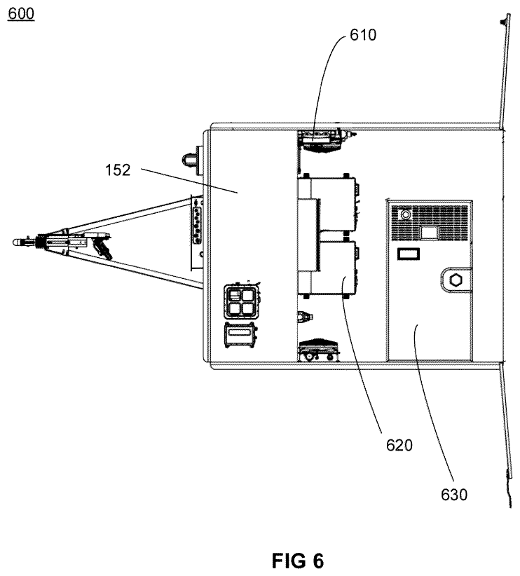

FIG. 6 illustrates mobile auxiliary system 600 suitable for use in the electric drawworks system of the present invention. In this embodiment, mobile auxiliary system 600 is comprised of battery pack 152, heat exchanger 610, motor control and power electronics 620, and generator 630. Since mobile auxiliary system 600 is mobile, it can be used in situations when using auxiliary system 150 is not ideal.

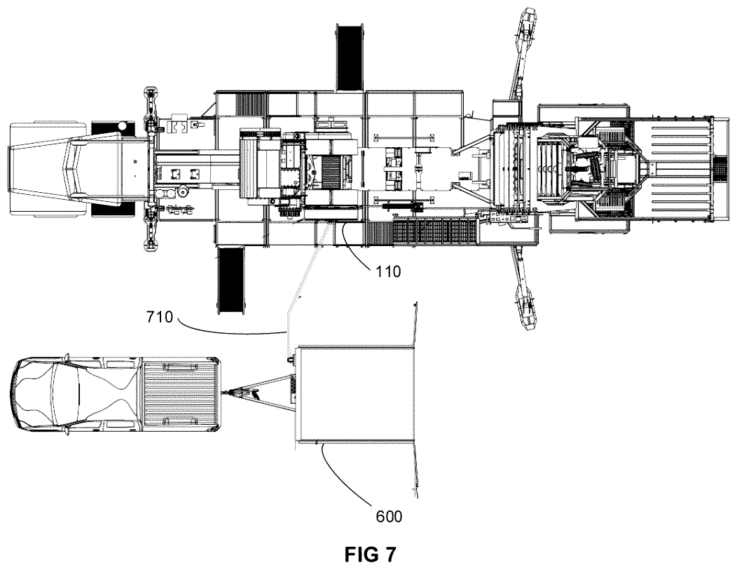

FIG. 7 illustrates an embodiment where retrofit motor assembly 110 of electric drawworks assembly installed on mobile service rig 100 is connected to mobile auxiliary system 600 via umbilical cable 710 so that retrofit motor assembly 110 is powered by mobile auxiliary system 600.

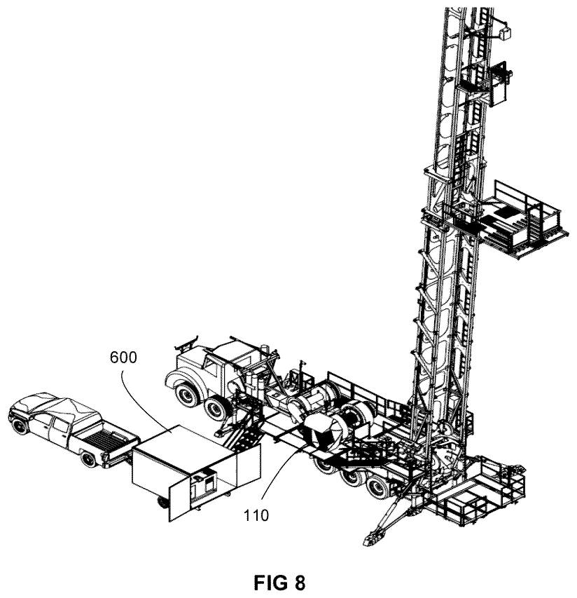

FIG. 8 illustrates a perspective view of mobile auxiliary system 600 and retrofit motor assembly 110 in an embodiment.

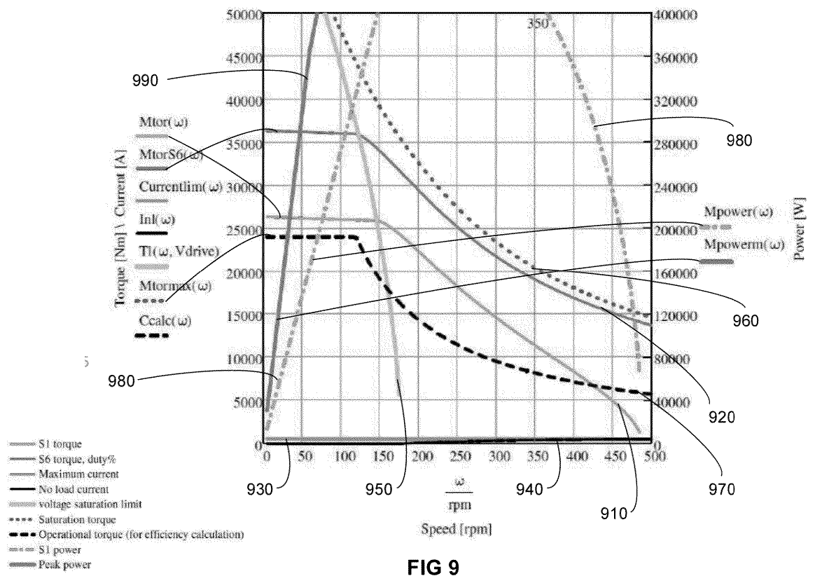

FIG. 9 illustrates the torque and power curves of motor assembly 110 as a function of speed of motor assembly 110. The continuous rating torque 910 of motor assembly 110 remains constant as motor speed is increased from 0 rpm until approximately 150 rpm and then decreases as motor speed is increased to approximately 500 rpm. Also, continuous operation, periodic duty torque 920 of motor assembly 110 remains constant as motor speed is increased from 0 rpm until approximately 125 rpm and then decreases as motor speed is increased to approximately 500 rpm.

FIG. 9 also illustrates that maximum current 930 remains approximately at the same value as the speed of motor assembly 110 is increased form 0 rpm to 500 rpm. No load current 940 similarly remains approximately at the same value as the speed of motor assembly 110 is increased form 0 rpm to 500 rpm. Voltage saturation limit 950 is somewhat reduced as motor assembly 110 speed is increased.

FIG. 9 also illustrates saturation torque 960 decreases somewhat as the speed of motor assembly 110 is increased. Operational torque 970, which can be used in efficiency calculations, remains somewhat constant as the speed of motor assembly 110 is increased from 0 rpm to approximately 115 rpm and then decreases as the speed of motor assembly 110 is further increased to 500 rpm.

FIG. 9 further illustrates continuous rating power 980 of motor assembly 110 increases as the speed of motor assembly 110 is increased from 0 rpm and then decreases as speed of motor assembly 110 is increased past a certain point (not shown). Also, peak power 990 of motor assembly 110 increases as the speed of motor assembly 110 is increased from 0 rpm.

Although the present invention has been described with reference to specific features and embodiments thereof, it is evident that various modifications and combinations can be made thereto without departing from the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

1. An electric motor assembly configured for use in controlling a drawworks assembly of a mobile service rig, the electric motor assembly comprising:
an electric motor configured for attachment to an auxiliary driveshaft of the drawworks; and
a disc brake configured to hold the motor in a stationary position when the drawworks is stopped.

2. The electric motor assembly of claim 1, wherein the electric motor is a double air gap motor comprising a rotor between two stators of a stator assembly.

3. The electric motor assembly of claim 1, wherein the motor assembly is sized to fit within an existing footprint of the mobile service rig.

4. The electric motor assembly of claim 1, wherein the electric motor is a low speed high torque motor.

5. The electric motor assembly of claim 1, wherein the assembly is suitable for retrofitting on the drawworks for replacement of a brake system attached to the auxiliary drive shaft.

6. The electric motor assembly of claim 1, wherein the electric motor assembly further comprises a flange mount configured to facilitate direct attachment of the motor to the auxiliary drive shaft.

7. The electric motor assembly of claim 1, wherein torque of the electric motor is used to control lowering of a load by the drawworks.

8. The electric motor assembly of claim 1, wherein the electric motor assembly is adapted for use with an electrical system.

9. An electric drawworks system adapted to move equipment in and out of oil wells, the system comprising:
an electric motor assembly as defined in any one of claims 1 to 8; and
a drawworks.

10. The system of claim 9 further comprising an electrical system.

11. The system of claim 9 further comprising a control system.

12. The system of claim 10, wherein the electrical system comprises a battery configured for storage of excess energy generated upon lowering of a load of the drawworks.

13. The system of claim 10, wherein the electrical system comprises a generator.

14. The system of claim 10, wherein the electrical system comprises an element for attachment to an electrical grid.

15. The system of claim 9, wherein the electric motor has a high ratio of maximum power potential to envelope size.

16. The system of claim 15 wherein the maximum power potential is achieved in part by using a heat sink.

17. A method for retrofitting an electric motor assembly as defined in any one of claims 1 to 8 to an auxiliary drive shaft of a drawworks comprising:
removing the auxiliary brake system from the auxiliary driveshaft;
mounting the electric motor to the auxiliary driveshaft.

18. The method of claim 17, wherein removing the auxiliary brake system comprises
removing an existing brake caliper from the drawworks;
removing the existing brake mounts from the drawworks;
removing a crown saver cylinder from the drawworks;
removing a shroud from the drawworks; and
removing a disc brake from an auxiliary drive shaft of the drawworks.

19. The method of claim 17 further comprising mounting a bolting flange mount to the drawworks.

20. The method of any one of claims 17 to 19, wherein the electric motor is a double air gap electric motor.

21. The method of claim 20, wherein mounting the double air gap electric motor comprises:
attaching a motor bell housing to the bolting flange mount;
attaching a motor rotor to the auxiliary drive shaft of the drawworks;
attaching a motor stator assembly to the motor bell housing; and
attaching a motor housing flange to the motor stator.

22. The method of claim 21, further comprising attaching a brake rotor to the motor rotor.
